(19) United States
(12) Patent Application Publication
(10) Pub. No.: US 2010/0044499 A1
(43) Pub. Date: Feb. 25, 2010

(54) Six rotor helicopter

(75) Inventors: Zenon Dragan, Saskatoon (CA); Orville Olm, Saskatoon (CA); Greg Wood, Saskatoon (CA)

Correspondence Address: NIXON & VANDERHYE, PC, 901 NORTH GLEBE ROAD, 11TH FLOOR, ARLINGTON, VA, 22203, US

(73) Assignee: DRAGANFLY INNOVATIONS INC., Saskatoon (CA)

(21) Appl. No.: 12/230,119

(22) Filed: Aug. 22, 2008

(51) Int. Cl. B64C 27/08

(52) U.S. Cl. 244/17.23

(57) ABSTRACT

A rotary wing aircraft is provided having at least three rotor pairs. Each rotor pair has an upper rotor and a lower rotor. During operation, the upper rotor and lower rotor rotate around a shared rotor axis with the upper rotor rotating in a first direction and the lower rotor rotating in an opposite direction By independently controlling the speed of rotation of each upper rotor and each lower rotor the aircraft can be made to ascend, descend, move forward, move backward, move side to side, yaw right and yaw left by only varying the relative speeds of rotations of the upper rotors and lower rotors.

This invention is in the field of rotary wing aircrafts or helicopters and more particularly rotary wing aircrafts with multiple horizontal coaxial rotor pairs.

### BACKGROUND

Helicopters using horizontal rotors have been known for a long time. They allow an aircraft to move vertically (allowing vertical take-offs), hover in the air, move side to side, etc. The use of horizontal rotors gives helicopters an unprecedented amount of movement in relation to a fixed wing craft.

However, conventional helicopters are typically very complex. Most conventional helicopters use a large horizontal rotor for lift and a smaller vertical rotor (the tail rotor) to counterbalance torque imposed on the helicopter by the rotation of the large lift rotor. By altering the pitch of the blades of the small vertical rotor, the entire helicopter can be pivoted from side to side or held straight.

The horizontal rotor must also be specially designed to cause the helicopter to tilt in different directions when required and to control the amount of lift created by the rotors. In one common conventional system, a swash plate assembly, comprising a fixed swash plate and a rotating swash plate, is used to change the pitch angle of the rotor blades. The swash plate assembly can be used in two ways: to change the pitch angle of all of the rotor blades collectively; or, by changing the pitch angle of the rotor blades individually and cyclically as they revolve. By changing the pitch angle of all of the rotor blades collectively, the amount of lift generated by the helicopter can be increased or decreased causing the helicopter to ascend or descend, respectively. By changing the pitch angle of the rotor blades cyclically as they revolve, the lift created on one side of the rotor can be increased causing the helicopter to tilt in a desired direction and thereby move in the direction the helicopter is tilting.

Tandem coaxial rotors have been developed to avoid the use of a smaller vertically mounted rotor. A pair of horizontal rotors rotating in opposite directions around a single axis are used. The counter-rotating pair of horizontal rotor blades can be used to balance out the torque created around the single axis by each of the two rotors and by altering the speeds of the two rotors relative to each other, the helicopter can be yawed left of right around the axis shared by the rotors.

While these tandem coaxial rotors remove the necessity for a tail rotor (vertical rotor) to counterbalance the rotational forces placed on a helicopter by a single rotor, to achieve all the desired movements of a conventional helicopter helicopters with tandem coaxial rotors have increased the mechanical complexity of the rotor systems. Rather than in more conventional systems which use two swashplates in the swashplate assembly to change the pitch of the rotor blades, tandem coaxial rotors typically use two swashplates for each rotor requiring four swashplates to be needed. In addition, provisions typically have to be made for the control system of the upper rotor to pass through the lower rotor control system.

While some remote controlled helicopters such as toys and drones have used simple versions of tandem coaxial rotor systems, they have often sacrificed the range of producible movements in order to reduce the mechanical complexity of the rotor system.

It is desirable in many applications to have a helicopter that can achieve all the movements of a conventional helicopter with a reduced mechanical complexity.

### SUMMARY OF THE INVENTION

It is an object of the present invention to provide an apparatus that overcomes problems in the prior art.

In an aspect, a rotary wing aircraft is provided. The aircraft comprising: a body; at least three rotor pairs, each rotor pair comprising a horizontally oriented upper rotor having at least two rotor blades and a horizontally oriented lower rotor having at least two rotor blades. During operation, the upper rotor and lower rotor rotate around a shared rotor axis with the upper rotor rotating in a first direction in a first plane fixed relative to the rotor axis and the lower rotor rotating in an other direction in a second plane fixed relative to the rotor axis. The aircraft allows the speed of rotation of each upper rotor to be varied independently from the lower rotors and the other upper rotors and the speed of rotation of each lower rotor to be varied independently from the upper rotors and the other lower rotors. The aircraft can be made to ascend, descend, move forward, move backward, move side to side, yaw right and yaw left by only varying the relative speeds of rotations of the upper rotors and lower rotors.

In an aspect, an aircraft is provided having three coaxial rotor pairs. Each rotor pair is connected to a shaft positioned at a regular interval around the body of the aircraft and contains an upper rotor rotating a first direction and a lower rotor rotating in an opposite direction. For each coaxial rotor pair, the rotation of the upper rotor is counterbalanced by the rotation of the lower rotor and vice versa. In this manner, by altering the speeds of rotation of the upper rotor and the lower rotor and changing the rotational speed differential between the upper rotor and the lower rotor, the rotational forces created by the rotating upper rotor and lower rotor can be balanced or used to create a torque effect in a desired direction around the rotor pair.

By altering the rotational speeds of the upper rotor and lower rotor in the different rotor pairs, the aircraft can perform a number of different maneuvers without requiring the complex mechanical linkages of a conventional helicopter. The aircraft can increase or decrease altitude by increasing or decreasing the speed of rotation, respectively, of all of the upper rotors and all of the lower rotors at the same time. The aircraft can be moved horizontally in any direction by decreasing the speed of rotation of one or more rotor pairs on a side of the aircraft facing the desired direction of movement, increasing the speed of rotation of the other rotor pairs on the opposite side of the aircraft from the desired direction of movement or a combination of both. This will cause the aircraft to tilt towards the desired direction of travel and create some horizontal thrust moving the aircraft in the desired direction. The aircraft can be yawed by decreasing the speed of rotation of the upper rotors and lower rotors rotating opposite to the desired direction of yaw, increasing the speed of rotation of the upper rotors and lower rotors rotating in the desired direction of yaw or both decreasing the speed of rotation of the upper rotors and lower rotors rotating opposite the desired direction of yaw and increasing the speed of rotation of the upper rotors and lower rotors rotating in the desired direction of yaw.

In this manner, the aircraft is capable of performing the maneuvers of a typical conventional helicopter, yet does not require the mechanical complexity of a typical conventional helicopter. To maximize the lift of the aircraft, the aircraft can be maneuvered so that all of the coaxial rotor pairs are used to create lift with none of them providing any horizontal thrust. Additionally, because of the number of different independently driven rotors, if a single rotor fails to operate, the remaining rotors can be used to compensate for the missing rotor allowing sufficient control to get the aircraft landed safely.

In a further aspect, the aircraft has two forward shafts supporting coaxial rotor shafts that can be folded to lie adjacent to a rear extending shaft supporting a coaxial rotor pair. In this position, the aircraft can be loaded into a pneumatic cannon or other propulsion device and quickly launched to a desired altitude where the forward shafts will rotate forward and the aircraft can be flown starting from the desired altitude.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is perspective view of an aircraft;

FIG. 2 is a top view of the aircraft shown in FIG. 1;

FIG. 3 is a perspective view of one rotor pair of the aircraft shown in FIG. 1;

FIG. 4 is a side view of the rotor pairs shown in FIG. 3;

FIG. 5 is a side view of the rotor pair shown in FIG. 3 with the rotor blades turned to show the pitch angle of the rotor blades; and

FIG. 6 is a schematic top view of an aircraft in a flying position in another aspect; and

FIG. 7 is a schematic top view of the aircraft of FIG. 6 in a folded position.

### DETAILED DESCRIPTION OF THE ILLUSTRATED EMBODIMENTS

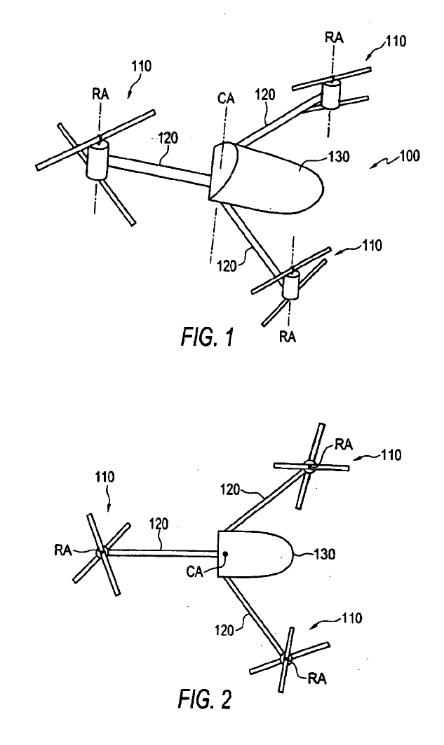

FIGS. 1 and 2 illustrate an aircraft 100 with three coaxial rotor pairs 110. Using the three coaxial rotor pairs 110, aircraft 100 is capable of performing the maneuvers a typical conventional helicopter is capable of, yet does not require the mechanical complexity of a typical conventional helicopter and all of the coaxial rotor pairs 110 can be used to create lift.

Each of the rotor pairs 110 are positioned at the end of a shaft 120 connected to a main body 130 of the aircraft 100. In an aspect, the shafts 120 are positioned extending at regular intervals around a central axis, CA, with each shaft 120 positioning the rotor pair 110 attached to the end of the shaft 120 the same distance away from the central axis, CA, as the other rotor pairs 110 and with each shaft 120 extending substantially one hundred twenty (120) degrees from the adjacent shafts 120.

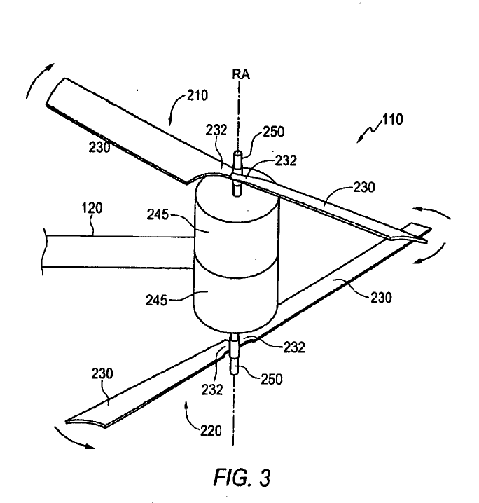

FIG. 3 illustrates a perspective view of one of the rotor pairs 110. The rotor pair 110 has an upper rotor 210 and a lower rotor 220. The upper rotor 210 and lower rotor 220 each have two rotor blades 230 that rotate around a rotor axis, RA.

In operation, when the upper rotor 210 and lower rotor 220 are rotated to generate lift, the upper rotor 210 and lower rotor 220 rotate in opposite directions around the shared rotor axis, RA. The rotation of the upper rotor 210 around the rotor axis, RA, causes the rotor pair 110 to want to rotate around the rotor axis, RA. However, the counter-rotation of the lower rotor 220 around the rotor axis, RA, causes the rotor pair 110 to want to rotate in the opposite direction around the rotor axis, RA. By altering the speeds of rotation of the upper rotor 210 and the lower rotor 220 and changing the rotational speed differential between the upper rotor 210 and the lower rotor 220, the rotational forces created by the rotating upper rotor 210 and lower rotor 220 can be balanced or used to create a torque effect in a desired direction around the rotor axis, RA.

Particularly when the aircraft 100 is a small remote control aircraft, such as toys, hobby devices or unmanned drones, each upper rotor 210 and lower rotor 220 can be independently driven by its own electric motor 245 with the upper rotor 210 attached to the output shaft 250 of the electric motor 245 and the lower rotor 220 attached to the output shaft 250 of the electric motor 245. The speed of the upper rotor 210 and lower rotor 220 can be varied independently of the each other by varying the current being directed to the corresponding electric motor 245.

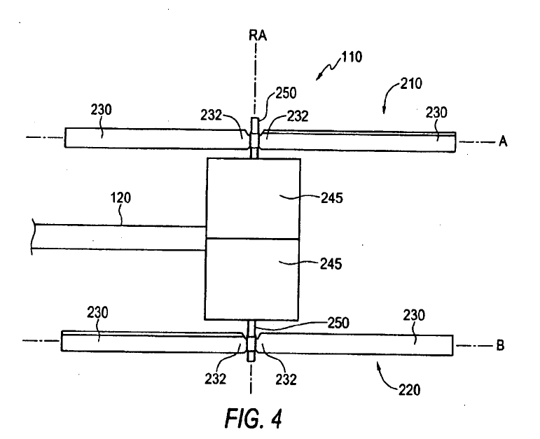

FIG. 4 illustrates a side view of a rotor pair 110. First ends 232 of the rotor blades 230 making up the upper rotor 210 and lower rotor 220 are fixedly connected to shafts 250 running along the rotor axis, RA, causing the rotor blade 230 to remain substantially perpendicular to the rotor axis, RA, when the shafts 250 are rotated. When the aircraft 100 is at rest on the ground, the rotor blades 230 are positioned substantially horizontally.

When the aircraft 100 is in flight, the upper rotor 210 rotates through a first plane, A that is substantially perpendicular to the rotor axis, RA, and the lower rotor 220 rotates through a second plane, B that is also substantially perpendicular to the rotor axis, RA causing planes A and B defined by the rotating upper rotor 210 and lower rotor 220, respectively, to remain substantially parallel to each other.

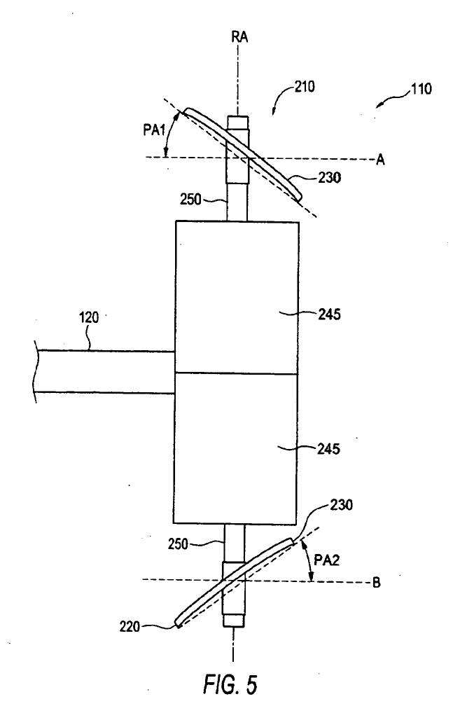

FIG. 5 illustrates a side view of a rotor pair 110. In an aspect, a pitch angle PA1 of the rotor blades 230 of the upper rotor 210 and a the pitch angle PA2 of the rotor blades 230 of the lower rotor 220 remain fixed relative to the rotor axis, RA.

In an aspect, the rotor blades 230 are sufficiently rigid so that they will not bend or twist when the aircraft 110 is in flight.

Referring again to FIGS. 1 and 2, the fixed upper rotors 210 and fixed lower rotors 220 allow the aircraft 100 to be manufactured with very few moving parts yet still maintain all of the movements of conventional helicopters. Rather than having a number of varying mechanical linkages connecting each of the rotors to vary the pitch angle of the rotor blades or the pitch of the rotors, only the electric motors 245 are moving with the upper rotors 210 and the lower rotors 220 rigidly connected to output shafts 250 of the electric motors 245.

The aircraft 100 can increase or decrease altitude by increasing or decreasing the speed of rotation of all of the upper rotors 210 and all of the lower rotors 220 at the same time. By increasing the speed of rotation of all of the upper rotors 210 and all of the lower rotors 220 the lift generated by all of the rotor pairs 110 is increased and the aircraft 100 can be made to rise vertically. Additionally, by decreasing the speed of rotation of all of the upper rotors 210 and all of the lower rotors 220, the altitude of the aircraft 100 can be decreased. In this manner, all six rotors making up the rotor pairs 100 can be used to generate vertical lift with none of the engine(s) capacity being directed to horizontal rotors.

The aircraft 100 can also be moved horizontally in any direction. To move the aircraft 100 in a desired horizontal direction, the speed of rotation of one or more rotor pairs 110 on a side of the aircraft 100 facing the desired direction are decreased or the speed of rotation of the other rotor pairs 110 can be increased. This will cause the aircraft 100 to tilt towards the desired direction of travel, tilting all of the upper rotors 210 and all of the lower rotors 220 downwards towards the desired direction and creating some horizontal thrust. This horizontal thrust causes the aircraft 100 lo move in the desired direction. The more the one or two rotor pairs 110 are slowed or the more the other rotor pair(s) 110 speed of rotation is increased, the greater the tilt of the aircraft 110 and the faster the aircraft 100 will travel in the desired direction.

The aircraft 100 can be yawed so that it rotates around the central axis, CA, either to the right or to the left by decreasing the speed of rotation of the upper rotors 210 and lower rotors 220 rotating opposite to the desired direction of yaw, increasing the speed of rotation of the upper rotors 210 and lower rotors 220 rotating in the desired direction of yaw or both decreasing the speed of rotation of the upper rotors 210 and lower rotors 220 rotating opposite the desired direction of yaw and increasing the speed of rotation of the upper rotors 210 and lower rotors 220 rotating in the desired direction of yaw.

In this manner, the aircraft 100 can be made to rise, descent, travel in any horizontal direction and yaw right or left in the same manner as a conventional helicopter without requiring the complex mechanical linkages required in a conventional helicopter.

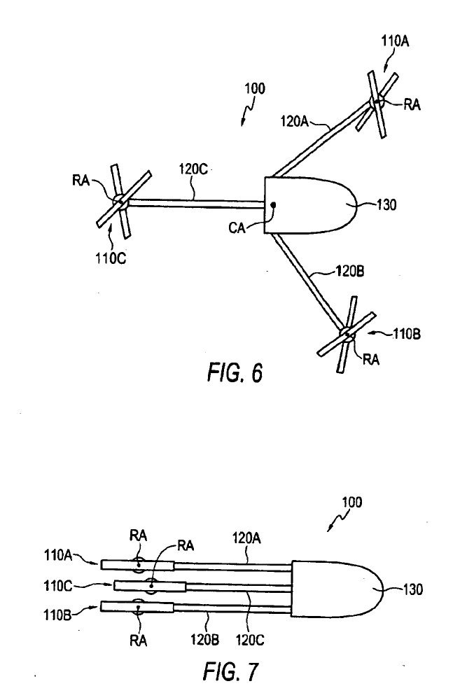

FIG. 6 illustrates the aircraft 100 in a further aspect. Aircraft 100 has two shafts 120A, 120B supporting rotor pairs 110A, 110B extending to the sides and slightly forward of the body 130 of the aircraft 100 and shaft 120C supporting rotor pair 110C extending to the rear of the body 130. The two front shafts 120A, 120B supporting rotor pairs 110A, 110B are pivotally attached to the body 130 of the aircraft 100 and the ends of the shafts 120A, 120B opposite to the ends supporting the rotor pairs 110A, 110B, so that the front shafts 120A, 120B can be pivoted rearwards of the body 130 of the aircraft 100 so that the shafts 120A, 120B are positioned adjacent the rear extending shaft 120C, as shown in FIG. 7. The rotor blades 230 can then be rotated so that they run substantially parallel to the shafts 120A, 120B,and 120C.

In this position the aircraft 100 can be launched using a pneumatic cannon, etc. into the air to achieve an initial altitude. From this initial altitude, the front shafts 120A, 120B can be rotated forward into their flying position, the rotor pairs 110 engaged so that the upper rotors 210 and lower rotors 220 are rotating, and the aircraft 100 can then be flown starting from this initial altitude the aircraft 100 has been launched to.

The front shafts 120A, 120B can be motor driven so that a small motor pivots the front shafts 120A, 120B forward into the flying position. Alternatively, in a further aspect, the front shafts 120A, 120B can be biased towards the front of the aircraft 100 and the flying position. In this manner, unless the shafts 120A, 120B are held adjacent to the rearward extending shaft 120C, the front shafts 120A, 120B will spring into position to the sides and slightly to the front of the body 130 of the aircraft 100. A mechanism is then used to secure the front shafts 120A, 120B adjacent to the rear shaft 120C for launching and when the aircraft is launched into the air, the mechanism triggered to release the front shafts 120A, 120B. The bias on the front shafts 120A, 120B will then swing the front shafts 120A, 120B forward into their flying position allowing the aircraft 100 to engage all of the rotor pairs 110 and begin to fly using the rotor pair 110.

In this manner, aircraft 100 can be quickly launched to a desired altitude over a desired area and then once in the flying position flown like a helicopter.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A rotary wing aircraft comprising:
a body;
at least three rotor pairs connected to the body,
each rotor pair comprising a horizontally oriented upper rotor having at least two rotor blades and a horizontally oriented lower rotor having at least two rotor blades,
wherein during operation the upper rotor and lower rotor rotate around a shared rotor axis with the upper rotor rotating in a first direction in a first plane fixed relative to the rotor axis and the lower rotor rotating in an other direction in a second plane fixed relative to the rotor axis,
and wherein the speed of rotation of each upper rotor can be varied independently from the lower rotors and the other upper rotors and the speed of rotation of each lower rotor can be varied independently from the upper rotors and the other lower rotors,
whereby the aircraft can be made to ascend, descend, move forward, move backward, move side to side, yaw right and yaw left by only varying the relative speeds of rotations of the upper rotors and lower rotors.

2. The aircraft of claim 1 wherein there are an odd number of rotor pairs.

3. The aircraft of claim 1 wherein for each rotor pair the first plane is substantially parallel to the second plane.

4. The aircraft of claim 3 wherein each rotor blade has a pitch angle that is fixed relative to the rotor axis.

5. The aircraft of claim 4 wherein there are three rotor pairs and each rotor pair attached to the body by a shaft, each shaft positioned approximately one hundred twenty degrees around a central axis from a shaft supporting an adjacent rotor pair.

6. The aircraft of claim 5 further comprising a plurality of motors with each motor driving one of: one of the upper rotors and one the lower rotors.

7. The aircraft of claim 6 wherein each motor is an electric motor and wherein the speed of each motor can be varied independently of the other motors by altering a current directed to the motor.

8. The aircraft of claim 7 wherein each rotor pair further comprises the motor for the upper rotor and the motor for the lower rotor positioned between the upper rotor and lower rotor.

9. The aircraft of claim 1 wherein increasing the speed of rotation of all of the upper rotors and all of the lower rotors increases the lift generated by the rotor pairs and causes the aircraft to ascend.

10. The aircraft of claim 1 wherein increasing the speed of rotation of all of the upper rotors and all of the lower rotors rotating in a first direction around a central axis of the aircraft causes the aircraft to rotate in the opposite direction around the central axis.

11. The aircraft of claim 1 wherein decreasing the speed of the rotation of all of the upper rotors and lower rotors rotating in a first direction around a central axis of the aircraft causes the aircraft to rotate in the first direction around the central axis.

12. The aircraft of claim 1 wherein decreasing the speed of rotation of the upper rotor and lower rotor in at least one rotor pair on a side of the aircraft causes the aircraft to tilt downwards to the side of the aircraft and move in the direction of the side of the aircraft.

13. The aircraft of claim 1 wherein increasing the speed of rotation of the upper rotor and lower rotor in at least one rotor pair on a side of the aircraft causes the aircraft to tilt downwards on an opposite side of the aircraft and move in the direction of the opposite side of the aircraft.

14. The aircraft of claim 1 wherein all the upper rotors rotate in a first direction and all of the lower rotors rotate in a second direction.

15. The aircraft of claim 4 wherein two of the shafts extend to the sides of the body and the other shaft extends to rearward from the body when the aircraft is in a flying position.

16. The aircraft of claim 15 wherein the two of the shafts are pivotally connected to the body of the aircraft such that the two of the shafts can be rotated so that the two of the shafts are positioned adjacent to the other shaft extending to the rearward from the body placing the aircraft in a folded position.

17. The aircraft of claim 16 wherein the two of the shafts are biased towards the flying position and a mechanism is used to hold the two of the shafts in place in the folded position.
